(19) United States
(12) Patent Application Publication
(10) Pub. No.: US 2026/0270004 A1
(43) Pub. Date: Sep. 10, 2026

(54) SIGNAL TRANSMISSION METHOD, APPARATUS, DEVICE, AND STORAGE MEDIUM

(71) Applicant: Beijing Xiaomi Mobile Software Co., Ltd., Beijing (CN)

(72) Inventors: Zhenyu ZHANG, Beijing (CN); Yumin WU, Beijing (CN); Liangang CHI, Beijing (CN)

(21) Appl. No.: 18/849,386

(22) PCT Filed: Mar. 30, 2022
(86) PCT No.: PCT/CN2022/084171

§ 371 Date: Sep. 20, 2024

(51) Int. Cl. H04L 5/00

(52) U.S. Cl. CPC H04L 5/005; H04L 5/0064

(57) ABSTRACT

A method for transmitting a signal is performed by a signal sending end. The method includes: determining a first transmission resource for a first signal and a second transmission resource for a second signal; determining whether the first signal is overlapped with the second signal based on the first transmission resource and the second transmission resource; determining a priority order of the first signal and the second signal in a case where the first signal is overlapped with the second signal; and sending at least one of the first signal or the second signal based on the priority order of the first signal and the second signal; wherein the first signal is a signal for sensing, and the second signal is a signal for communication.

### CROSS-REFERENCE

The present application is a U.S. National Stage of International Application No. PCT/CN2022/084171, filed on Mar. 30, 2022, the content of which is incorporated herein by reference in its entirety.

### TECHNICAL FIELD

The present disclosure relates to the field of communication technologies, and in particular to a method, apparatus, and device for transmitting a signal, and a storage medium.

### BACKGROUND

In wireless communication systems, communication-sensing systems can realize sensing and detection functions on the basis of communication, so they have received extensive attention and research. In the related arts, the communication-sensing systems typically need to transmit communication signals and sensing signals.

### SUMMARY

An aspect of embodiments of the present disclosure provides a method for transmitting a signal, applied to a signal sending end, and the method includes:
determining a first transmission resource for a first signal and a second transmission resource for a second signal;
determining whether the first signal is overlapped with the second signal based on the first transmission resource and the second transmission resource;
determining a priority order of the first signal and the second signal in a case where the first signal is overlapped with the second signal; and
sending the first signal and/or the second signal based on the priority order of the first signal and the second signal;
wherein the first signal is a signal for sensing, and the second signal is a signal for communication.

Another aspect of embodiments of the present disclosure provides a method for transmitting a signal, applied to a signal receiving end, and the method includes:
determining a first transmission resource for a first signal and a second transmission resource for a second signal;
determining whether the first signal is overlapped with the second signal based on the first transmission resource and the second transmission resource;
determining a priority order of the first signal and the second signal in a case where the first signal is overlapped with the second signal; and
receiving the first signal and/or the second signal based on the priority order of the first signal and the second signal;
wherein the first signal is a signal for sensing, and the second signal is a signal for communication.

Still another aspect of embodiments of the present disclosure provides a communication device, including a processor and a memory, wherein a computer program is stored in the memory, and the processor executes the computer program stored in the memory to cause the communication device to execute the method provided in the aspect of the above embodiments.

Still another aspect of embodiments of the present disclosure provides a communication device, including a processor and a memory, wherein a computer program is stored in the memory, and the processor executes the computer program stored in the memory to cause the communication device to execute the method provided in the other aspect of the above embodiments.

### BRIEF DESCRIPTION OF THE DRAWINGS

The above and/or additional aspects and advantages of the present disclosure will become apparent and readily understood from the following description of embodiments with reference to the accompanying drawings, in which:

FIG. 1 is a schematic flowchart of a method for transmitting a signal provided by an embodiment of the present disclosure;

FIG. 2a is a schematic flowchart of a method for transmitting a signal provided by another embodiment of the present disclosure;

FIG. 2b is a schematic structural diagram of a slot in a first transmission resource being overlapped with a slot in a second transmission resource provided by an embodiment of the present disclosure;

FIG. 3a is a schematic flowchart of a method for transmitting a signal provided by yet another embodiment of the present disclosure;

FIG. 3b is a schematic structural diagram of a slot in a transmission resource with a later starting position be overlapped with a slot in an interval provided by an embodiment of the present disclosure;

FIG. 4a is a schematic flowchart of a method for transmitting a signal provided by still another embodiment of the present disclosure;

FIG. 4b is a schematic structural diagram of discarding, on an overlapping resource, transmission of a low-priority signal among a first signal and a second signal provided by an embodiment of the present disclosure;

FIG. 4c is a schematic structural diagram of discarding transmission of a low-priority signal among a first signal and a second signal provided by an embodiment of the present disclosure;

FIG. 5 is a schematic flowchart of a method for transmitting a signal provided by still another embodiment of the present disclosure;

FIG. 6 is a schematic flowchart of a method for transmitting a signal provided by still another embodiment of the present disclosure;

FIG. 7 is a schematic flowchart of a method for transmitting a signal provided by still another embodiment of the present disclosure;

FIG. 8 is a schematic flowchart of a method for transmitting a signal provided by still another embodiment of the present disclosure;

FIG. 9 is a schematic flowchart of a method for transmitting a signal provided by still another embodiment of the present disclosure;

FIG. 10 is a schematic flowchart of a method for transmitting a signal provided by still another embodiment of the present disclosure;

FIG. 11 is a schematic structural diagram of an apparatus for transmitting a signal provided by an embodiment of the present disclosure;

FIG. 12 is a schematic structural diagram of an apparatus for transmitting a signal provided by another embodiment of the present disclosure;

FIG. 13 is a block diagram of a user equipment provided by an embodiment of the present disclosure; and

FIG. 14 is a block diagram of a network side device provided by an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the embodiments of the present disclosure. Instead, they are merely examples of apparatuses and methods consistent with some aspects of embodiments of the present disclosure as recited in the appended claims.

The terms used in embodiments of the present disclosure are merely for the purpose of describing particular embodiments and are not intended to limit embodiments of the present disclosure. As used in embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, the first indication information may also be referred to as the second information, and similarly, the second information may also be referred to as the first information. Depending on the context, the word “if” as used herein can be interpreted as “upon” or “when” or “in response to determination”.

As described above, in wireless communication systems, communication-sensing systems can realize sensing and detection functions on the basis of communication, so they have received extensive attention and research. In the related arts, the communication-sensing systems typically need to transmit communication signals and sensing signals. The communication signals and the sensing signals will inevitably collide in the communication-sensing systems.

However, in the related arts, there is currently no method to deal with the situation where “the communication signals and the sensing signals in the communication-sensing systems collide”. When the communication signals and the sensing signals in the communication-sensing systems collide, signal sending ends in the communication-sensing systems do not know how to handle it, which will affect the communication-sensing performance of the communication-sensing systems.

A method/apparatus/device for transmitting a signal, and a storage medium provided by embodiments of the present disclosure are described in detail below with reference to the accompanying drawings.

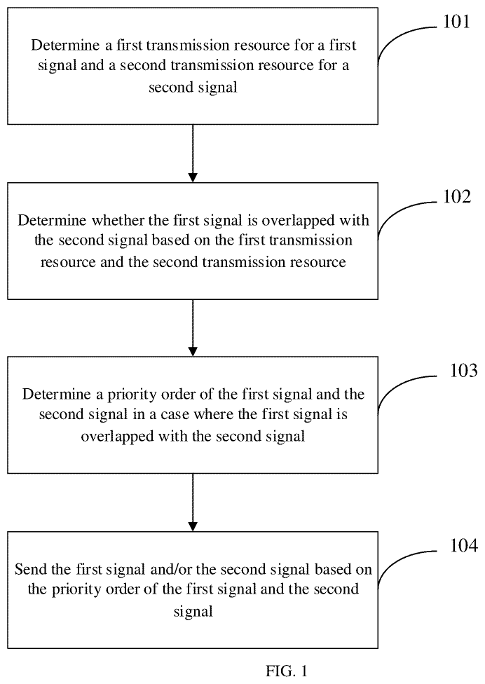

FIG. 1 is a schematic flowchart of a method for transmitting a signal provided by an embodiment of the present disclosure. The method is performed by a signal sending end. As shown in FIG. 1, the method for transmitting the signal may include steps 101 to 104.

In the step 101, a first transmission resource for a first signal and a second transmission resource for a second signal are determined.

It should be noted that in an embodiment of the present disclosure, the signal sending end may be a terminal device or a network device. The terminal device may refer to a device that provides speech and/or data connectivity for a user. The terminal device may communicate with one or more core networks via a Radio Access Network (RAN). The terminal device may be an Internet of Things terminal, such as a sensor device, a mobile phone (or a “cellular” phone), and a computer having an Internet of Things terminal, for example, a fixed, portable, pocket-sized, handheld, computer built-in or vehicle-mounted device. For example, it may be a station (STA), a subscriber unit, a subscriber station, a mobile station, a mobile, a remote station, an access point, a remote terminal, an access terminal, a user terminal, or a user agent. Alternatively, the UE may also be a device of an unmanned aerial vehicle. Alternatively, the terminal device may also be an in-vehicle device, for example, a trip computer with a wireless communication function, or a wireless terminal external to the trip computer. Alternatively, the terminal device may also be a roadside device, for example, a street light, a signal light, or other roadside device with a wireless communication function, etc.

In an embodiment of the present disclosure, when the signal sending end is the terminal device, the first transmission resource for the first signal and the second transmission resource for the second signal may be configured by the network device. When the signal sending end is the network device, the first transmission resource for the first signal and the second transmission resource for the second signal may be determined by the network device itself.

In an embodiment of the present disclosure, the first signal and the second signal may have different purposes. Specifically, in an embodiment of the present disclosure, the first signal may be a signal for sensing, and the first signal may be, for example, a signal for detecting detection information of a sensing target or a signal for positioning, and the detection information may include, but is not limited to, information such as a distance of the sensing target, a speed of the sensing target, and an angle of the sensing target. The second signal may be a signal for communication, and the second signal may be, for example, a signal for sending data, or controlling the sending of information, or assisting the sending of the data.

Furthermore, in an embodiment of the present disclosure, the first transmission resource may be a resource for transmitting the first signal, and the second transmission resource may be a resource for transmitting the second signal. In addition, the first transmission resource and the second transmission resource may each include at least one of:
a time domain resource (such as a slot, a symbol, etc.) position; or
a frequency domain resource (such as Subcarrier Spacing (SCS), Bandwidth Part (BWP), etc.) position.

Specifically, in an embodiment of the present disclosure, the time domain resource position may include a sending period of the signal, for example, the sending period may be 10 ms (milliseconds). In addition, the frequency domain resource position may include a frequency number, for example, the frequency number may be frequency −1.

It should be noted that in an embodiment of the present disclosure, both the first transmission resource and the second transmission resource may be time domain resource positions.

In another embodiment of the present disclosure, both the first transmission resource and the second transmission resource may be frequency domain resource positions.

In yet another embodiment of the present disclosure, the first transmission resource may be a time domain resource position, and the second transmission resource may be a frequency domain resource position.

In still another embodiment of the present disclosure, the first transmission resource may be a frequency domain resource position, and the second transmission resource may be a time domain resource position.

In the step 102, it is determined whether the first signal is overlapped with the second signal based on the first transmission resource and the second transmission resource.

Specifically, whether the first signal and the second signal overlap is determined by determining whether resource overlapping occurs between the first signal and the second signal, and a specific method of “determining whether the first signal and the second signal overlap” will be described in detail in subsequent embodiments.

In the step 103, in a case where the first signal is overlapped with the second signal, a priority order of the first signal and the second signal is determined.

In an embodiment of the present disclosure, a method for determining priorities of the first signal and the second signal may include at least one of methods 1 to 3.

Method 1: the priorities of the first signal and the second signal are determined based on a configuration by the network device.

In an embodiment of the present disclosure, the determining the priorities of the first signal and the second signal based on the configuration by the network device may include at least one of methods a to c:

Method a: the priorities of the first signal and the second signal are determined based on a parameter (such as a higher layer parameter) configured by the network device, and the priority order is determined based on the priorities of the first signal and the second signal.

In an embodiment of the present disclosure, a communication priority indication field (e.g., Com-PriorityIndex) and a sensing priority indication field (e.g., Sen-PriorityIndex) may be introduced into the higher layer parameter. Com-PriorityIndex is used to indicate the priority of the second signal, and Sen-PriorityIndex is used to indicate the priority of the first signal. In an implementation, the indication field used to indicate the communication priority may also continue to use phy-PriorityIndex in the existing protocol. Specifically, in an embodiment of the present disclosure, Com-PriorityIndex may be an N-bit number, where N is a positive integer. Sen-PriorityIndex may be an M-bit number, where M is a positive integer. M and N may be equal or unequal. When Com-PriorityIndex has different values, the indicated priority of the second signal is different, and when Sen-PriorityIndex has different values, the indicated priority of the first signal is different. Furthermore, the value of Com-PriorityIndex or Sen-PriorityIndex may be positively correlated with the indicated priority of the signal (e.g., when the value of Com-PriorityIndex is greater than the value of Sen-PriorityIndex, it indicates that the priority of the second signal is higher than that of the first signal) or negatively correlated with the indicated priority of the signal (e.g., when the value of Com-PriorityIndex is greater than the value of Sen-PriorityIndex, it indicates that the priority of the second signal is lower than that of the first signal).

For example, in an embodiment of the present disclosure, it is assumed that both Com-PriorityIndex and Sen-PriorityIndex are 1-bit numbers, and the value of Com-PriorityIndex or Sen-PriorityIndex is positively correlated with the indicated priority of the signal. In this case, if Com-PriorityIndex in the higher layer parameter configured by the network device is 0, it indicates that the priority of the second signal is 0. If Sen-PriorityIndex in the higher layer parameter configured by the network device is 1, it indicates that the priority of the first signal is 1. In this case, it is considered that the priority of the first signal is higher than the priority of the second signal. It should be understood that the field names used in the present disclosure are merely exemplary and do not constitute a limitation.

Method b: the priorities of the first signal and the second signal are determined based on a Downlink Control Information (DCI) signaling configured by the network device, and the priority order is determined based on the priorities of the first signal and the second signal.

Specifically, in an embodiment of the present disclosure, an indication field indicating the priorities of the first signal and the second signal may be introduced into the DCI signaling. If two bits in the DCI are to be used to indicate the priorities of the first signal and the second signal, respectively, a Most Significant Bit (MSB) field in the DCI signaling may be used to indicate the priority of the second signal, and a Least Significant Bit (LSB) field in the DCI signaling may be used to indicate the priority of the first signal. When the MSB in the DCI signaling is different, the indicated priority of the second signal is different; and when the LSB in the DCI signaling is different, the indicated priority of the first signal is different. In addition, a value of the MSB or LSB may be positively correlated with the indicated priority of the signal (e.g., when the value of the MSB is greater than the value of the LSB, it indicates that the priority of the second signal is higher than that of the first signal) or negatively correlated with the indicated priority of the signal (e.g., when the value of the MSB is greater than the value of the LSB, it indicates that the priority of the second signal is lower than that of the first signal).

For example, in an embodiment of the present disclosure, it is assumed that the MSB in the DCI signaling indicates the priority of the second signal, the LSB in the DCI signaling indicates the priority of the first signal, and the value of the MSB or LSB is positively correlated with the indicated priority of the signal, when the MSB in the DCI signaling is 0, it indicates that the priority of the second signal is 0, and when the LSB in the DCI signaling is 1, it indicates that the priority of the first signal is 1, it is considered in this case that the priority of the first signal is higher than the priority of the second signal..

Method c: when the priorities of the first signal and the second signal are not configured by the network device, it is determined that the first signal and the second signal have the same priority.

Specifically, in an embodiment of the present disclosure, when the network device does not configure the priorities of the first signal and the second signal through the higher layer parameter and the DCI signaling, the signal sending end considers that the first signal and the second signal have the same priority by default, for example, the signal sending end may consider that the priorities of the first signal and the second signal are both 0 or 1 by default.

Method 2: the priority order of the first signal and the second signal is determined based on a protocol agreement.

In an embodiment of the present disclosure, for example, any of the following priority orders may be determined based on the protocol agreement:
the priority of the second signal is higher than the priority of the first signal;
the priority of the first signal is higher than the priority of the second signal; or
the first signal and the second signal have the same priority.

Method 3: the signal sending end autonomously determines the priority order of the first signal and the second signal.

In an embodiment of the present disclosure, the method for the signal sending end to autonomously determine the priority order of the first signal and the second signal may include steps a and b.

In the step a, a transmission scenario corresponding to the signal sending end is determined.

In an embodiment of the present disclosure, the transmission scenario may include, for example: an Enhanced Mobile Broadband (eMBB) transmission scenario, an Ultra-Reliable and Low-Latency Communications (URLLC) transmission scenario, and a massive Machine Type Communications (mMTC) transmission scenario.

In an embodiment of the present disclosure, a method for determining the transmission scenario corresponding to the signal sending end may include at least one of:
determining the transmission scenario corresponding to the signal sending end based on the protocol agreement; or
determining, based on indication by the network device, the transmission scenario corresponding to the signal sending end (e.g., the network device may directly indicate that the current transmission scenario corresponding to the signal sending end is the eMBB transmission scenario, the URLLC transmission scenario, or the mMTC transmission scenario).

It should be noted that in an embodiment of the present disclosure, with respect to the method that “the signal sending end determines, based on the indication by the network device, the transmission scenario corresponding to the signal sending end”, the signal sending end may first send a request message to the network device to request the network device to indicate the transmission scenario corresponding to the signal sending end. After that, the signal sending end may receive the transmission scenario indicated based on the request message by the network device.

In the step b, the priority order of the first signal and the second signal is determined based on the transmission scenario corresponding to the signal sending end.

In an embodiment of the present disclosure, the method for determining the priorities of the first signal and the second signal based on the transmission scenario corresponding to the signal sending end may include: making a priority of a signal, among the first signal and the second signal, whose purpose corresponds to a requirement of the transmission scenario be higher than a priority of a signal, among the first signal and the second signal, whose purpose does not correspond to the requirement of the transmission scenario.

Specifically, different transmission scenarios have different requirements. in a case where the transmission scenario corresponding to the signal sending end is the eMBB transmission scenario, since a main requirement of the eMBB transmission scenario is that: an ultra-high transmission data rate is required, that is, a requirement for the signal for communication is high, the signal sending end may autonomously determine that the second signal has a high priority.

In a case where the transmission scenario corresponding to the signal sending end is the URLLC transmission scenario, since a main requirement of the URLLC transmission scenario (such as an autonomous driving scenario) is that: higher reliability and lower latency are required, that is, a requirement for the signal for sensing is higher, the signal sending end may autonomously determine that the first signal has a high priority.

In a case where the transmission scenario corresponding to the signal sending end is the mMTC transmission scenario, since a main requirement of the mMTC transmission scenario is that: the signal sending end needs to support a large number of connections and is insensitive to the data rate and latency, that is, a requirement for the signal for communication is high, the signal sending end may autonomously determine that the second signal has a high priority.

In the step 104, the first signal and/or the second signal are sent based on the priority order of the first signal and the second signal.

In an embodiment of the present disclosure, when the priorities of the first signal and the second signal are different, the signal sending end may specifically transmit the first signal and/or the second signal by performing a first sending operation. In another embodiment of the present disclosure, when the priorities of the first signal and the second signal are the same, the signal sending end may specifically transmit the first signal and/or the second signal by performing a second sending operation.

The first sending operation and the second sending operation will be described in detail in subsequent embodiments.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

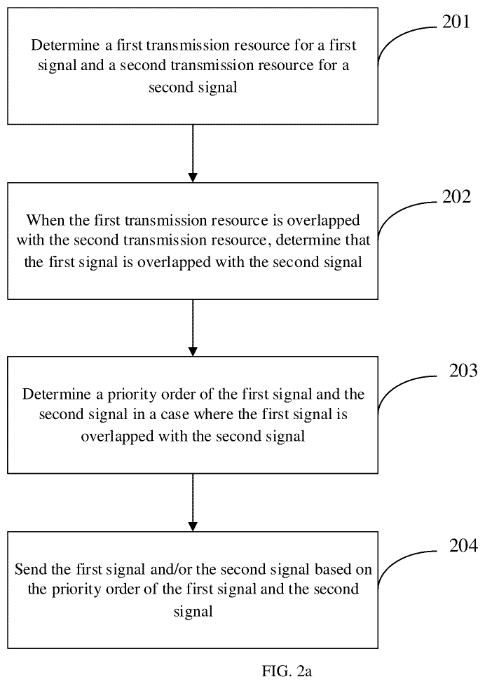

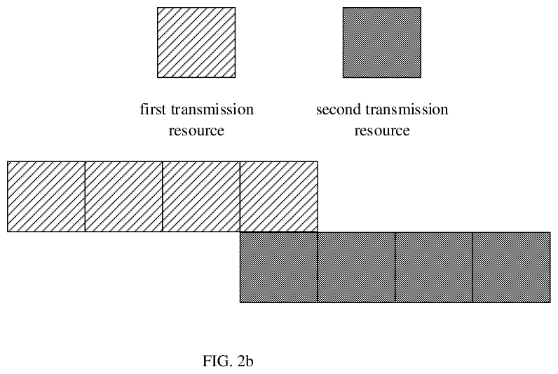

FIG. 2a is a schematic flowchart of a method for transmitting a signal provided by an embodiment of the present disclosure. The method is performed by a signal sending end. As shown in FIG. 2a, the method for transmitting the signal may include steps 201 to 204.

In the step 201, a first transmission resource for a first signal and a second transmission resource for a second signal are determined.

In the step 202, when the first transmission resource is overlapped with the second transmission resource, it is determined that the first signal is overlapped with the second signal.

In an embodiment of the present disclosure, first, it may be determined whether the first transmission resource is overlapped with the second transmission resource, and when it is determined that the first transmission resource is overlapped with the second transmission resource, it is determined that the first signal is overlapped with the second signal.

Specifically, in an embodiment of the present disclosure, a criterion for determining whether the first transmission resource is overlapped with the second transmission resource may be specifically: determining whether a time domain resource (such as the slot, the symbol) position in the first transmission resource is overlapped with a time domain resource position in the second transmission resource, and/or determining whether a frequency domain resource (such as the SCS, the BWP) position in the first transmission resource is overlapped with a frequency domain resource position in the second transmission resource.

Specifically, in an embodiment of the present disclosure, when the time domain resource position in the first transmission resource is overlapped with the time domain resource position in the second transmission resource, and/or the frequency domain resource position in the first transmission resource is overlapped with the frequency domain resource position in the second transmission resource, it is considered that the first signal is overlapped with the second signal.

For example, the transmission resource being the slot is taken as an example. FIG. 2b is a schematic structural diagram of a slot in a first transmission resource being overlapped with a slot in a second transmission resource provided by an embodiment of the present disclosure. As shown in FIG. 2b, a fourth slot in the first transmission resource is overlapped with a first slot in the second transmission resource, and in this case, it is considered that the first signal and the second signal overlap.

In the step 203, in a case where the first signal is overlapped with the second signal, a priority order of the first signal and the second signal is determined.

In the step 204, the first signal and/or the second signal are sent based on the priority order of the first signal and the second signal.

For other detailed descriptions of the steps 201 to 204, reference may be made to the above embodiment description, which will not be repeated here in embodiments of the present disclosure.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

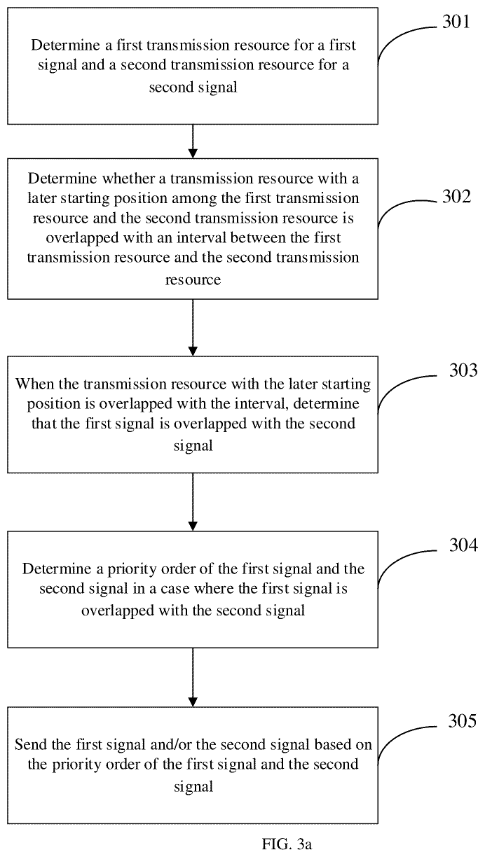

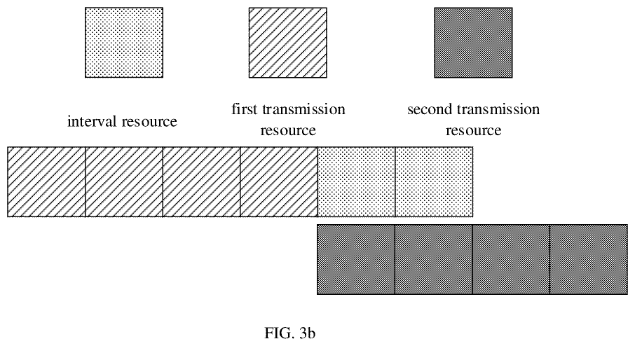

FIG. 3a is a schematic flowchart of a method for transmitting a signal provided by an embodiment of the present disclosure. The method is performed by a signal sending end. As shown in FIG. 3a, the method for transmitting the signal may include steps 301 to 305.

In the step 301, a first transmission resource for a first signal and a second transmission resource for a second signal are determined.

In the step 302, it is determined whether a transmission resource with a later starting position among the first transmission resource and the second transmission resource is overlapped with an interval between the first transmission resource and the second transmission resource.

In an embodiment of the present disclosure, the interval is a guard interval between the first transmission resource and the second transmission resource to prevent interference between the first signal transmitted on the first transmission resource and the second signal transmitted on the second transmission resource.

Furthermore, in an embodiment of the present disclosure, determining whether the transmission resource with the later starting position is overlapped with the interval between the first transmission resource and the second transmission resource specifically includes: determining whether a time domain resource (such as the slot) position in the transmission resource with the later starting position is overlapped with the interval, and/or determining whether a frequency domain resource position in the transmission resource with the later starting position is overlapped with the interval.

In the step 303, when the transmission resource with the later starting position is overlapped with the interval, it is determined that the first signal is overlapped with the second signal.

Specifically, in an embodiment of the present disclosure, when the time domain resource position in the transmission resource with the later starting position is overlapped with the interval, and/or when the frequency domain resource position in the transmission resource with the later starting position is overlapped with the interval, it is considered that the first signal and the second signal overlap.

For example, in an embodiment of the present disclosure, the transmission resource being the slot is taken as an example. FIG. 3b is a schematic structural diagram of a slot in a transmission resource with a later starting position being overlapped with a slot in an interval provided by an embodiment of the present disclosure. As shown in FIG. 3b, the interval between the first transmission resource and the second transmission resource includes two slots, the second transmission resource is the above-mentioned transmission resource with the later starting position, and the first two slots of the second transmission resource overlap with the two slots in the interval, it is considered that the first signal and the second signal overlap.

In the step 304, in a case where the first signal is overlapped with the second signal, a priority order of the first signal and the second signal is determined.

In the step 305, the first signal and/or the second signal are sent based on the priority order of the first signal and the second signal.

For other detailed descriptions of the steps 301 to 305, reference may be made to the above embodiment description, which will not be repeated here in embodiments of the present disclosure.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

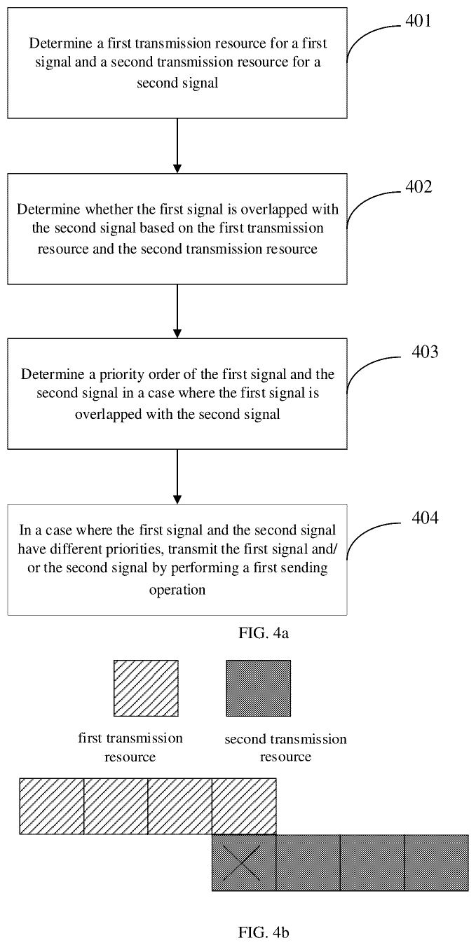

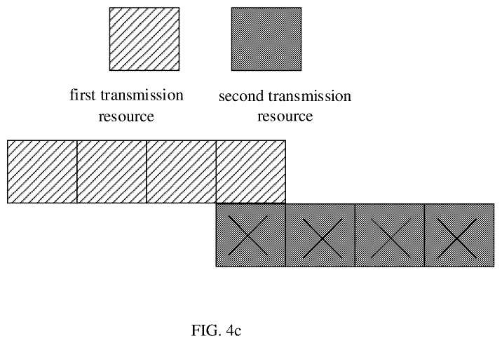

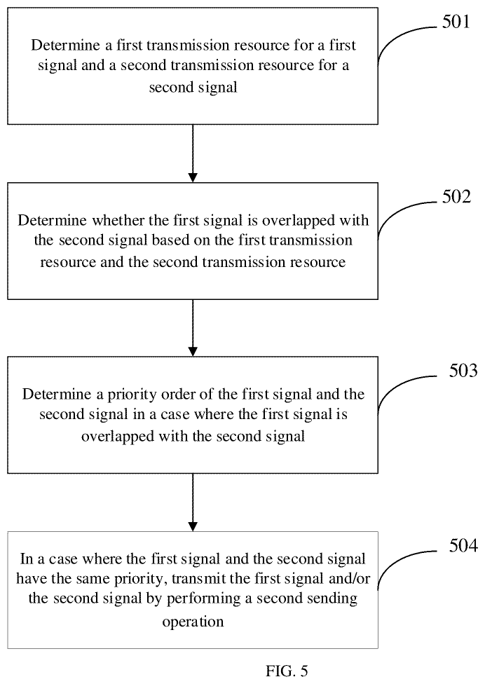

FIG. 4a is a schematic flowchart of a method for transmitting a signal provided by an embodiment of the present disclosure. The method is performed by a signal sending end. As shown in FIG. 4a, the method for transmitting the signal may include steps 401 to 404.

In the step 401, a first transmission resource for a first signal and a second transmission resource for a second signal are determined.

In the step 402, it is determined whether the first signal is overlapped with the second signal based on the first transmission resource and the second transmission resource.

In the step 403, in a case where the first signal is overlapped with the second signal, a priority order of the first signal and the second signal is determined.

For detailed descriptions of the steps 401 to 403, reference may be made to the above embodiment description, which will not be repeated here in embodiments of the present disclosure.

In the step 404, in a case where the priorities of the first signal and the second signal are different, the first signal and/or the second signal are sent by performing a first sending operation.

In an embodiment of the present disclosure, the first sending operation includes any one of:
discarding, on an overlapping resource, transmission of a low-priority signal among the first signal and the second signal;
discarding the transmission of the low-priority signal among the first signal and the second signal;
prioritizing transmission of a high-priority signal among the first signal and the second signal, and when the transmission of the high-priority signal is completed, transmitting, in a delayed manner, the low-priority signal among the first signal and the second signal;
prioritizing the transmission of the high-priority signal among the first signal and the second signal, and when the transmission of the high-priority signal is completed, transmitting, in the delayed manner, the low-priority signal among the first signal and the second signal, an interval between the high-priority signal that is transmitted preferentially and the low-priority signal that is transmitted in the delayed manner is greater than a threshold value;
transmitting the first signal on a first part of the overlapping resource, and transmitting the second signal on a second part of the overlapping resource, the first part of the overlapping resource is not overlapped with the second part of the overlapping resource; or
transmitting the first signal on the first part of the overlapping resource, and transmitting the second signal on the second part of the overlapping resource, the first part of the overlapping resource is not overlapped with the second part of the overlapping resource, and an interval between the first part of the overlapping resource and the second part of the overlapping resource is greater than a threshold value.

In an embodiment of the present disclosure, the threshold value may be predefined by a protocol and/or configured by the network device.

For example, it is assumed that the priority of the first signal is higher than that of the second signal, and the transmission resource is the slot. In an embodiment of the present disclosure, FIG. 4b is a schematic structural diagram of discarding, on an overlapping resource, transmission of a low-priority signal among a first signal and a second signal provided by an embodiment of the present disclosure. As shown in FIG. 4b, when the fourth slot of the first transmission resource and the first slot of the second transmission resource overlap, only the low-priority signal (i.e., the second signal) on the overlapping resource between the first transmission resource and the second transmission resource may be discarded. In other words, only the second signal on the first slot of the second transmission resource may be discarded. In another embodiment of the present disclosure, FIG. 4c is a schematic structural diagram of discarding transmission of a low-priority signal among a first signal and a second signal provided by an embodiment of the present disclosure. As shown in FIG. 4c, when the fourth slot of the first transmission resource and the first slot of the second transmission resource overlap, the low-priority signal (i.e., the second signal) may be discarded completely. In other words, all second signals on the first to fourth slots of the second transmission resource may be discarded.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

FIG. 5 is a schematic flowchart of a method for transmitting a signal provided by an embodiment of the present disclosure. The method is performed by a signal sending end. As shown in FIG. 5, the method for transmitting the signal may include steps 501 to 504.

In the step 501, a first transmission resource for a first signal and a second transmission resource for a second signal are determined.

In the step 502, it is determined whether the first signal is overlapped with the second signal based on the first transmission resource and the second transmission resource.

In the step 503, in a case where the first signal is overlapped with the second signal, a priority order of the first signal and the second signal is determined.

In the step 504, in a case where the priorities of the first signal and the second signal are the same, the first signal and/or the second signal are transmitted by performing a second sending operation.

In an embodiment of the present disclosure, the second sending operation includes any one of:
discarding, on an overlapping resource, transmission of a signal with a later starting position among the first signal and the second signal;
discarding the transmission of the signal with the later starting position among the first signal and the second signal;
prioritizing transmission of a signal with an earlier starting position among the first signal and the second signal, and when the transmission of the signal with the earlier starting position is completed, transmitting, in a delayed manner, the signal with the later starting position among the first signal and the second signal;
prioritizing the transmission of the signal with the earlier starting position among the first signal and the second signal, and when the transmission of the signal with the earlier starting position is completed, transmitting, in the delayed manner, the signal with the later starting position among the first signal and the second signal, an interval between the signal with the earlier starting position that is transmitted preferentially and the signal with the later starting position that is transmitted in the delayed manner is greater than a threshold value;
transmitting the first signal on a first part of the overlapping resource, and transmitting the second signal on a second part of the overlapping resource, the first part of the overlapping resource is not overlapped with the second part of the overlapping resource;
transmitting the first signal on the first part of the overlapping resource, and transmitting the second signal on the second part of the overlapping resource, the first part of the overlapping resource is not overlapped with the second part of the overlapping resource, and an interval between the first part of the overlapping resource and the second part of the overlapping resource is greater than a threshold value; or
transmitting the first signal or the second signal by default based on a protocol specification.

For other detailed descriptions of the steps 501 to 504, reference may be made to the above embodiment description, which will not be repeated here in embodiments of the present disclosure.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

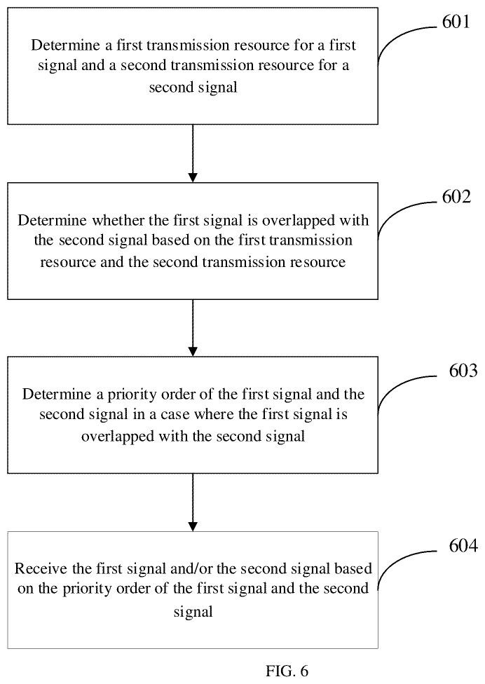

FIG. 6 is a schematic flowchart of a method for transmitting a signal provided by an embodiment of the present disclosure. The method is performed by a signal receiving end. As shown in FIG. 6, the method for transmitting the signal may include steps 601 to 604.

In the step 601, a first transmission resource for a first signal and a second transmission resource for a second signal are determined.

In an embodiment of the present disclosure, the signal receiving end may be a terminal device or a network device. When the signal receiving end is the terminal device, the first transmission resource for the first signal and the second transmission resource for the second signal may be configured by the network device. When the signal receiving end is the network device, the first transmission resource for the first signal and the second transmission resource for the second signal may be determined by the network device itself.

In an embodiment of the present disclosure, the first signal and the second signal may have different purposes. Specifically, in an embodiment of the present disclosure, the first signal may be a signal for sensing, and the first signal may be, for example, a signal for detecting detection information of a sensing target or a signal for positioning, and the detection information may include, but is not limited to, information such as a distance of the sensing target, a speed of the sensing target, and an angle of the sensing target. The second signal may be a signal for communication, and the second signal may be, for example, a signal for sending data, or controlling the sending of information, or assisting the sending of the data.

Furthermore, in an embodiment of the present disclosure, the first transmission resource may be a resource for transmitting the first signal, and the second transmission resource may be a resource for transmitting the second signal. In addition, the first transmission resource and the second transmission resource may each include at least one of:
a time domain resource position; or
a frequency domain resource position.

Specifically, in an embodiment of the present disclosure, the time domain resource position may be a sending period of the signal, for example, the sending period may be 10 ms (milliseconds). In addition, the frequency domain resource position may be a frequency number, for example, the frequency number may be frequency −1.

It should be noted that in an embodiment of the present disclosure, both the first transmission resource and the second transmission resource may be time domain resource positions.

In another embodiment of the present disclosure, both the first transmission resource and the second transmission resource may be frequency domain resource positions.

In yet another embodiment of the present disclosure, the first transmission resource may be a time domain resource position, and the second transmission resource may be a frequency domain resource position.

In still another embodiment of the present disclosure, the first transmission resource may be a frequency domain resource position, and the second transmission resource may be a time domain resource position.

In the step 602, it is determined whether the first signal is overlapped with the second signal based on the first transmission resource and the second transmission resource.

In the step 603, in a case where the first signal is overlapped with the second signal, a priority order of the first signal and the second signal is determined.

In the step 604, the first signal and/or the second signal are received based on the priority order of the first signal and the second signal.

For other detailed descriptions of the steps 601 to 604, reference may be made to the above embodiment description, which will not be repeated here in embodiments of the present disclosure.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

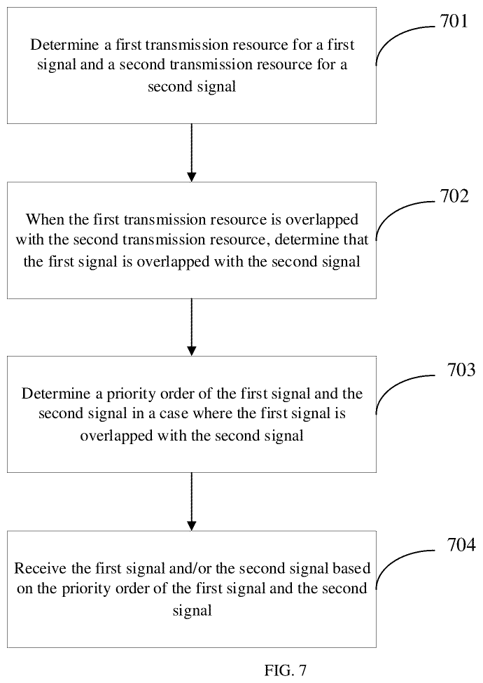

FIG. 7 is a schematic flowchart of a method for transmitting a signal provided by an embodiment of the present disclosure. The method is performed by a signal receiving end. As shown in FIG. 7, the method for transmitting the signal may include steps 701 to 704.

In the step 701, a first transmission resource for a first signal and a second transmission resource for a second signal are determined.

In the step 702, when the first transmission resource is overlapped with the second transmission resource, it is determined that the first signal is overlapped with the second signal.

In the step 703, in a case where the first signal is overlapped with the second signal, a priority order of the first signal and the second signal is determined.

In the step 704, the first signal and/or the second signal are received based on the priority order of the first signal and the second signal.

For other detailed descriptions of the steps 701 to 704, reference may be made to the above embodiment description, which will not be repeated here in embodiments of the present disclosure.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

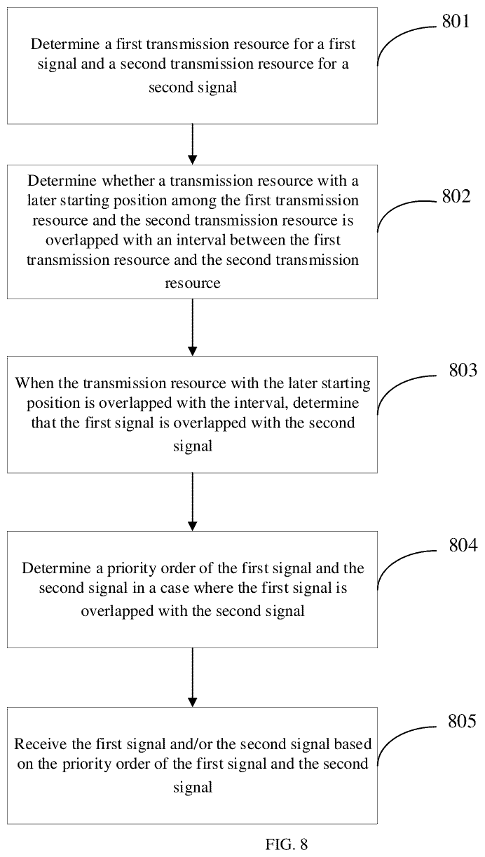

FIG. 8 is a schematic flowchart of a method for transmitting a signal provided by an embodiment of the present disclosure. The method is performed by a signal receiving end. As shown in FIG. 8, the method for transmitting the signal may include steps 801 to 805.

In the step 801, a first transmission resource for a first signal and a second transmission resource for a second signal are determined.

In the step 802, it is determined whether a transmission resource with a later starting position among the first transmission resource and the second transmission resource is overlapped with an interval between the first transmission resource and the second transmission resource.

In the step 803, when the transmission resource with the later starting position is overlapped with the interval, it is determined that the first signal is overlapped with the second signal.

In the step 804, in a case where the first signal is overlapped with the second signal, a priority order of the first signal and the second signal is determined.

In the step 805, the first signal and/or the second signal are received based on the priority order of the first signal and the second signal.

For other detailed descriptions of the steps 701 to 704, reference may be made to the above embodiment description, which will not be repeated here in embodiments of the present disclosure.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

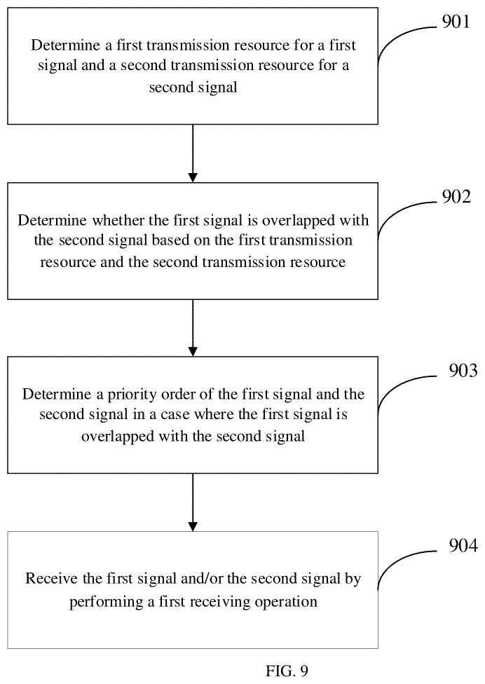

FIG. 9 is a schematic flowchart of a method for transmitting a signal provided by an embodiment of the present disclosure. The method is performed by a signal receiving end. As shown in FIG. 9, the method for transmitting the signal may include steps 901 to 904.

In the step 901, a first transmission resource for a first signal and a second transmission resource for a second signal are determined.

In the step 902, it is determined whether the first signal is overlapped with the second signal based on the first transmission resource and the second transmission resource.

In the step 903, in a case where the first signal is overlapped with the second signal, a priority order of the first signal and the second signal is determined.

In the step 904, the first signal and/or the second signal are received by performing a first receiving operation.

In an embodiment of the present disclosure, the first receiving operation includes any one of:
discarding, on an overlapping resource, reception of a low-priority signal among the first signal and the second signal;
discarding the reception of the low-priority signal among the first signal and the second signal;
prioritizing reception of a high-priority signal among the first signal and the second signal, and when the reception of the high-priority signal is completed, receiving, in a delayed manner, the low-priority signal among the first signal and the second signal;
prioritizing the reception of the high-priority signal among the first signal and the second signal, and when the reception of the high-priority signal is completed, receiving, in the delayed manner, the low-priority signal among the first signal and the second signal; an interval between the high-priority signal that is received preferentially and the low-priority signal that is received in the delayed manner is greater than a threshold value;
receiving the first signal on a first part of the overlapping resource, and receiving the second signal on a second part of the overlapping resource, the first part of the overlapping resource is not overlapped with the second part of the overlapping resource; or
receiving the first signal on the first part of the overlapping resource, and receiving the second signal on the second part of the overlapping resource, the first part of the overlapping resource is not overlapped with the second part of the overlapping resource, and an interval between the first part of the overlapping resource and the second part of the overlapping resource is greater than a threshold value.

For other detailed descriptions of the steps 901 to 904, reference may be made to the above embodiment description, which will not be repeated here in embodiments of the present disclosure.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

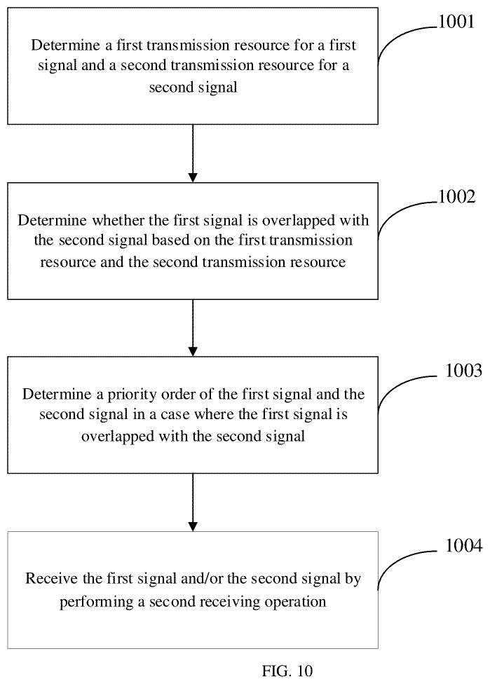

FIG. 10 is a schematic flowchart of a method for transmitting a signal provided by an embodiment of the present disclosure. The method is performed by a signal receiving end. As shown in FIG. 10, the method for transmitting the signal may include steps 1001 to 1004.

In the step 1001, a first transmission resource for a first signal and a second transmission resource for a second signal are determined.

In the step 1002, it is determined whether the first signal is overlapped with the second signal based on the first transmission resource and the second transmission resource.

In the step 1003, in a case where the first signal is overlapped with the second signal, a priority order of the first signal and the second signal is determined.

In the step 1004, the first signal and/or the second signal are received by performing a second receiving operation.

In an embodiment of the present disclosure, the second receiving operation includes any one of:
discarding, on an overlapping resource, reception of a signal with a later starting position among the first signal and the second signal;
discarding the reception of the signal with the later starting position among the first signal and the second signal;
prioritizing reception of a signal with an earlier starting position among the first signal and the second signal, and when the reception of the signal with the earlier starting position is completed, receiving, in a delayed manner, the signal with the later starting position among the first signal and the second signal;
prioritizing the reception of the signal with the earlier starting position among the first signal and the second signal, and when the reception of the signal with the earlier starting position is completed, receiving, in the delayed manner, the signal with the later starting position among the first signal and the second signal; an interval between the signal with the earlier starting position that is transmitted preferentially and the signal with the later starting position that is transmitted in the delayed manner is greater than a threshold value;
receiving the first signal on a first part of the overlapping resource, and receiving a second signal on a second part of the overlapping resource, the first part of the overlapping resource is not overlapped with the second part of the overlapping resource;
receiving the first signal on a first part of the overlapping resource, and receiving the second signal on a second part of the overlapping resource, the first part of the overlapping resource is not overlapped with the second part of the overlapping resource, and an interval between the first part of the overlapping resource and the second part of the overlapping resource is greater than a threshold value; or
receiving the first signal or the second signal by default based on a protocol specification.

For other detailed descriptions of the steps 1001 to 1004, reference may be made to the above embodiment description, which will not be repeated here in embodiments of the present disclosure.

In summary, in the method for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

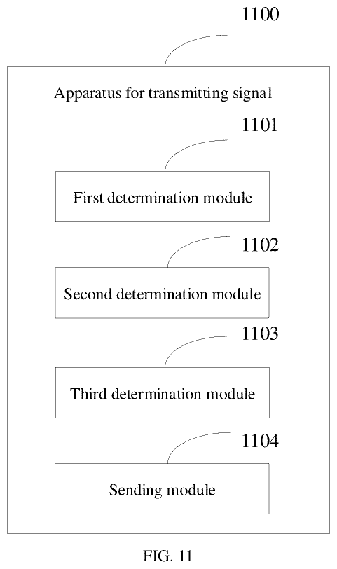

FIG. 11 is a schematic structural diagram of an apparatus 1100 for transmitting a signal provided by an embodiment of the present disclosure. As shown in FIG. 11, the apparatus may include:
a first determination module 1101, configured to determine a first transmission resource for a first signal and a second transmission resource for a second signal;
a second determination module 1102, configured to determine whether the first signal is overlapped with the second signal based on the first transmission resource and the second transmission resource;
a third determination module 1103, configured to determine a priority order of the first signal and the second signal in a case where the first signal is overlapped with the second signal; and
a sending module 1104, configured to send the first signal and/or the second signal based on the priority order of the first signal and the second signal;
the first signal is a signal for sensing, and the second signal is a signal for communication.

In summary, in the apparatus for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

In an embodiment of the present disclosure, the second determination module is further configured to:
when the first transmission resource is overlapped with the second transmission resource, determine that the first signal is overlapped with the second signal.

In an embodiment of the present disclosure, the second determination module is further configured to:
determine whether a transmission resource with a later starting position among the first transmission resource and the second transmission resource is overlapped with an interval between the first transmission resource and the second transmission resource; and
when the transmission resource with the later starting position is overlapped with the interval, determine that the first signal is overlapped with the second signal.

In an embodiment of the present disclosure, the third determination module is further configured to:
determine priorities of the first signal and the second signal based on a configuration by a network device, and determine the priority order based on the priorities of the first signal and the second signal;
determine the priority order of the first signal and the second signal based on a protocol agreement; and
autonomously determine, by the signal sending end, the priority order of the first signal and the second signal.

In an embodiment of the present disclosure, the third determination module is further configured to:
determine the priorities of the first signal and the second signal based on a parameter and/or a Downlink Control Information (DCI) signaling configured by the network device; and
in a case where the priorities of the first signal and the second signal are not configured by the network device, determine the first signal and the second signal have the same priority.

In an embodiment of the present disclosure, the third determination module is further configured to:
determine a transmission scenario corresponding to the signal sending end; and
determine the priority order of the first signal and the second signal based on the transmission scenario corresponding to the signal sending end.

In an embodiment of the present disclosure, the third determination module is further configured to:
determine the transmission scenario corresponding to the signal sending end based on a protocol agreement; or
determine the transmission scenario corresponding to the signal sending end based on an indication by the network device.

In an embodiment of the present disclosure, the third determination module is further configured to:
make a priority of a signal, among the first signal and the second signal, whose purpose corresponds to a requirement of the transmission scenario be higher than a priority of a signal, among the first signal and the second signal, whose purpose does not correspond to the requirement of the transmission scenario.

In an embodiment of the present disclosure, the sending module is further configured to:
in a case where the first signal and the second signal have different priorities, transmit the first signal and/or the second signal by performing a first sending operation;
the first sending operation includes any one of:
discarding, on an overlapping resource, transmission of a low-priority signal among the first signal and the second signal;
discarding the transmission of the low-priority signal among the first signal and the second signal;
prioritizing transmission of a high-priority signal among the first signal and the second signal, and when the transmission of the high-priority signal is completed, transmitting, in a delayed manner, the low-priority signal among the first signal and the second signal;
prioritizing the transmission of the high-priority signal among the first signal and the second signal, and when the transmission of the high-priority signal is completed, transmitting, in the delayed manner, the low-priority signal among the first signal and the second signal, wherein an interval between the high-priority signal that is transmitted preferentially and the low-priority signal that is transmitted in the delayed manner is greater than a threshold value;
transmitting the first signal on a first part of the overlapping resource, and transmitting the second signal on a second part of the overlapping resource, wherein the first part of the overlapping resource is not overlapped with the second part of the overlapping resource; or
transmitting the first signal on the first part of the overlapping resource, and transmitting the second signal on the second part of the overlapping resource, wherein the first part of the overlapping resource is not overlapped with the second part of the overlapping resource, and an interval between the first part of the overlapping resource and the second part of the overlapping resource is greater than a threshold value.

In an embodiment of the present disclosure, the sending module is further configured to:
in a case where the first signal and the second signal have the same priority, transmit the first signal and/or the second signal by performing a second sending operation;
the second sending operation includes any one of:
discarding, on an overlapping resource, transmission of a signal with a later starting position among the first signal and the second signal;
discarding the transmission of the signal with the later starting position among the first signal and the second signal;
prioritizing transmission of a signal with an earlier starting position among the first signal and the second signal, and when the transmission of the signal with the earlier starting position is completed, transmitting, in a delayed manner, the signal with the later starting position among the first signal and the second signal;
prioritizing the transmission of the signal with the earlier starting position among the first signal and the second signal, and when the transmission of the signal with the earlier starting position is completed, transmitting, in the delayed manner, the signal with the later starting position among the first signal and the second signal, wherein an interval between the signal with the earlier starting position that is transmitted preferentially and the signal with the later starting position that is transmitted in the delayed manner is greater than a threshold value;
transmitting the first signal on a first part of the overlapping resource, and transmitting the second signal on a second part of the overlapping resource, wherein the first part of the overlapping resource is not overlapped with the second part of the overlapping resource;
transmitting the first signal on the first part of the overlapping resource, and transmitting the second signal on the second part of the overlapping resource, wherein the first part of the overlapping resource is not overlapped with the second part of the overlapping resource, and an interval between the first part of the overlapping resource and the second part of the overlapping resource is greater than a threshold value; or
transmitting the first signal or the second signal by default based on a protocol specification.

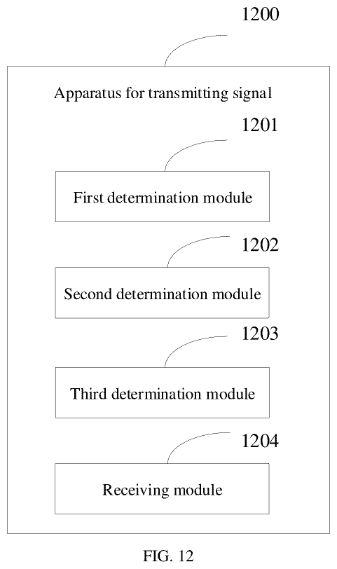

FIG. 12 is a schematic structural diagram of an apparatus 1200 for transmitting a signal provided by an embodiment of the present disclosure. As shown in FIG. 12, the apparatus may include:
a first determination module 1201, configured to determine a first transmission resource for a first signal and a second transmission resource for a second signal;
a second determination module 1202, configured to determine whether the first signal is overlapped with the second signal based on the first transmission resource and the second transmission resource;
a third determination module 1203, configured to determine a priority order of the first signal and the second signal in a case where the first signal is overlapped with the second signal; and
a receiving module 1204, configured to receive the first signal and/or the second signal based on the priority order of the first signal and the second signal;
the first signal is a signal for sensing, and the second signal is a signal for communication.

In summary, in the apparatus for transmitting the signal provided in embodiments of the present disclosure, the signal sending end may first determine the first transmission resource for the first signal and the second transmission resource for the second signal, determine whether the first signal and the second signal overlap based on the first transmission resource and the second transmission resource, and then, in the case where the first signal and the second signal overlap, determine the priority order of the first signal and the second signal, and send the first signal and/or the second signal based on the priority order of the first signal and the second signal. It can be seen that in embodiments of the present disclosure, when the signal sending end determines that the first signal (such as the signal for sensing) and the second signal (such as the signal for communication) overlap, it will transmit the first signal and/or the second signal based on the priority order of the first signal and the second signal. That is, the present disclosure provides a processing method for the situation where “signals in the communication-sensing system overlap”, then when the signals in the communication-sensing system overlap, the signal sending end can use the method of the present disclosure to ensure the normal transmission of the signals in the communication-sensing system, thereby ensuring the communication-sensing performance of the communication-sensing system.

In an embodiment of the present disclosure, the second determination module is further configured to:
when the first transmission resource is overlapped with the second transmission resource, determine that the first signal is overlapped with the second signal.

In an embodiment of the present disclosure, the second determination module is further configured to:
determine whether a transmission resource with a later starting position among the first transmission resource and the second transmission resource is overlapped with an interval between the first transmission resource and the second transmission resource; and when the transmission resource with the later starting position is overlapped with the interval, determine that the first signal is overlapped with the second signal.

In an embodiment of the present disclosure, the third determination module is further configured to:
determine priorities of the first signal and the second signal based on a configuration by a network device, and determine the priority order based on the priorities of the first signal and the second signal;
determine the priority order of the first signal and the second signal based on a protocol agreement; and
autonomously determine, by the signal receiving end, the priority order of the first signal and the second signal.

In an embodiment of the present disclosure, the third determination module is further configured to:
determine the priorities of the first signal and the second signal based on a parameter and/or a Downlink Control Information (DCI) signaling configured by the network device; and
in a case where the priorities of the first signal and the second signal are not configured by the network device, determine the first signal and the second signal have the same priority.

In an embodiment of the present disclosure, the third determination module is further configured to:
determine a transmission scenario corresponding to the signal receiving end; and
determine the priority order of the first signal and the second signal based on the transmission scenario corresponding to the signal receiving end.

In an embodiment of the present disclosure, the third determination module is further configured to:
determine the transmission scenario corresponding to the signal receiving end based on a protocol agreement; or
determine the transmission scenario corresponding to the signal receiving end based on an indication by the network device.

In an embodiment of the present disclosure, the third determination module is further configured to:
make a priority of a signal, among the first signal and the second signal, whose purpose corresponds to a requirement of the transmission scenario be higher than a priority of a signal, among the first signal and the second signal, whose purpose does not correspond to the requirement of the transmission scenario.

In an embodiment of the present disclosure, the receiving module is further configured to:
receive the first signal and/or the second signal by performing a first receiving operation;
the first receiving operation includes any one of:
discarding, on an overlapping resource, reception of a low-priority signal among the first signal and the second signal;
discarding the reception of the low-priority signal among the first signal and the second signal;
prioritizing reception of a high-priority signal among the first signal and the second signal, and when the reception of the high-priority signal is completed, receiving, in a delayed manner, the low-priority signal among the first signal and the second signal;
prioritizing the reception of the high-priority signal among the first signal and the second signal, and when the reception of the high-priority signal is completed, receiving, in the delayed manner, the low-priority signal among the first signal and the second signal; wherein an interval between the high-priority signal that is received preferentially and the low-priority signal that is received in the delayed manner is greater than a threshold value;
receiving the first signal on a first part of the overlapping resource, and receiving the second signal on a second part of the overlapping resource, wherein the first part of the overlapping resource is not overlapped with the second part of the overlapping resource; or
receiving the first signal on a first part of the overlapping resource, and receiving the second signal on a second part of the overlapping resource, wherein the first part of the overlapping resource is not overlapped with the second part of the overlapping resource, and an interval between the first part of the overlapping resource and the second part of the overlapping resource is greater than a threshold value.

In an embodiment of the present disclosure, the receiving module is further configured to:
receive the first signal and/or the second signal by performing a second receiving operation;
the second receiving operation includes any one of:
discarding, on an overlapping resource, reception of a signal with a later starting position among the first signal and the second signal;
discarding the reception of the signal with the later starting position among the first signal and the second signal;
prioritizing reception of a signal with an earlier starting position among the first signal and the second signal, and when the reception of the signal with the earlier starting position is completed, receiving, in a delayed manner, the signal with the later starting position among the first signal and the second signal;
prioritizing the reception of the signal with the earlier starting position among the first signal and the second signal, and when the reception of the signal with the earlier starting position is completed, receiving, in the delayed manner, the signal with the later starting position among the first signal and the second signal, wherein an interval between the signal with the earlier starting position that is received preferentially and the signal with the later starting position that is received in the delayed manner is greater than a threshold value;
receiving the first signal on a first part of the overlapping resource, and receiving the second signal on a second part of the overlapping resource, wherein the first part of the overlapping resource is not overlapped with the second part of the overlapping resource;
receiving the first signal on a first part of the overlapping resource, and receiving the second signal on a second part of the overlapping resource, wherein the first part of the overlapping resource is not overlapped with the second part of the overlapping resource, and an interval between the first part of the overlapping resource and the second part of the overlapping resource is greater than a threshold value; or
receiving the first signal or the second signal by default based on a protocol specification.

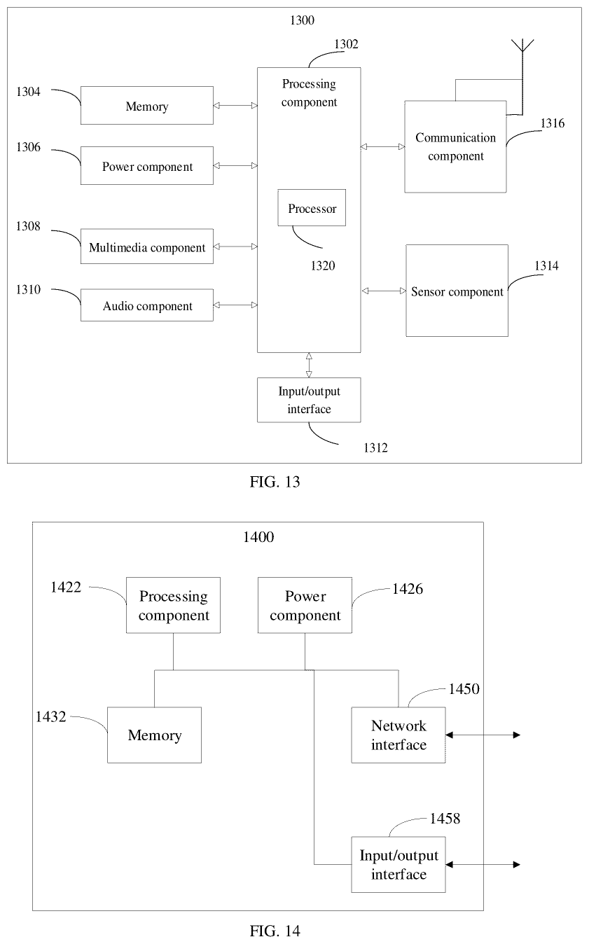

FIG. 13 is a block diagram of a User Equipment (UE) 1300 provided by an embodiment of the present disclosure. For example, the UE 1300 may be a mobile phone, a computer, a digital broadcast terminal device, a messaging device, a gaming console, a tablet, a medical device, an exercise device, a personal digital assistant, etc.

Referring to FIG. 13, the UE 1300 may include at least one of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls overall operations of the UE 1300, such as the operations associated with display, telephone calls, data communications, camera operations, and recording operations. The processing component 1302 may include at least one processor 1320 to execute instructions to perform all or part of the steps in the above described methods. Moreover, the processing component 1302 may include at least one module which facilitate the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the UE 1300. Examples of such data include instructions for any applications or methods operated on the UE 1300, contact data, phonebook data, messages, pictures, video, etc. The memory 1304 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the UE 1300. The power component 1306 may include a power management system, at least one power source, and any other components associated with the generation, management, and distribution of power in the UE 1300.

The multimedia component 1308 includes a screen providing an output interface between the UE 1300 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensors may not only sense a boundary of a touch or swipe action, but also sense a wake-up time and a pressure associated with the touch or swipe action. In some embodiments, the multimedia component 1308 includes a front camera and/or a rear camera. The front camera and the rear camera may receive an external multimedia datum while the UE 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone (MIC) configured to receive an external audio signal when the UE 1300 is in an operation mode, such as a call mode, a recording mode, and a voice recognition mode. The received audio signal may be further stored in the memory 1304 or transmitted via the communication component 1316. In some embodiments, the audio component 1310 further includes a speaker to output audio signals.

The I/O interface 1312 provides an interface between the processing component 1302 and peripheral interface modules, such as a keyboard, a click wheel, buttons, and the like. The buttons may include, but are not limited to, a home button, a volume button, a starting button, and a locking button.

The sensor component 1314 includes at least one sensor to provide state assessments of various aspects of the UE 1300. For instance, the sensor component 1314 may detect an open/closed state of the UE 1300, relative positioning of components, e.g., the display and the keypad, of the UE 1300, a change in position of the UE 1300 or a component of the UE 1300, a presence or absence of user contact with the UE 1300, an orientation or an acceleration/deceleration of the UE 1300, and a change in temperature of the UE 1300. The sensor component 1314 may include a proximity sensor configured to detect the presence of nearby objects without any physical contact. The sensor component 1314 may further include a light sensor, such as a CMOS or CCD image sensor, for use in imaging applications. In some embodiments, the sensor component 1314 may further include an accelerometer sensor, a gyroscope sensor, a magnetic sensor, a pressure sensor, or a temperature sensor.

The communication component 1316 is configured to facilitate communication, wired or wirelessly, between the UE 1300 and other devices. The UE 1300 may access a wireless network based on a communication standard, such as WiFi, 2G, or 3G, or a combination thereof. In an embodiment, the communication component 1316 receives a broadcast signal or broadcast associated information from an external broadcast management system via a broadcast channel. In an embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the UE 1300 may be implemented with at least one application specific integrated circuit (ASIC), digital signal processor (DSP), digital signal processing device (DSPD), programmable logic device (PLD), field programmable gate array (FPGA), controller, micro-controller, microprocessor, or other electronic components, for performing the above described methods.

FIG. 14 is a block diagram of a network side device 1400 provided by an embodiment of the present disclosure. For example, the network side device 1400 may be provided as a network device. Referring to FIG. 14, the network side device 1400 includes a processing component 1422, which further includes at least one processor and a memory resource represented by a memory 1432 for storing instructions executable by the processing component 1422, such as an application program. The application program stored in the memory 1432 may include one or more modules, each corresponding to a set of instructions. In addition, the processing component 1422 is configured to execute the instructions to execute the aforementioned any method applied on the network side device, for example, the method shown in FIG. 1.

The network side device 1400 may further include: a power component 1426 configured to perform power management of the network side device 1400, a wired or wireless network interface 1450 configured to connect the network side device 1400 to the network, and an input/output (I/O) interface 1458. The network side device 1400 may operate an operating system stored in the memory 1432, such as Windows Server ™, Mac OS X™, Unix™, Linux™, FreeBSD™, or the like.

In the above embodiments provided by the present disclosure, the methods provided by embodiments of the present disclosure are introduced from the perspectives of the network side device and the UE. In order to achieve various functions of the methods provided in embodiments of the present disclosure, the network side device and the UE may include hardware structures and software modules, and the various functions are implemented in the form of hardware structures, software modules, or hardware structures plus software modules. One of the various functions may be implemented in the form of hardware structures, software modules, or hardware structure plus software modules.

In the above embodiments provided by the present disclosure, the methods provided by embodiments of the present disclosure are introduced from the perspectives of the network side device and the UE. In order to achieve various functions of the methods provided in embodiments of the present disclosure, the network side device and the UE may include hardware structures and software modules, and the various functions are implemented in the form of hardware structures, software modules, or hardware structures plus software modules. One of the various functions may be implemented in the form of hardware structures, software modules, or hardware structure plus software modules.

Embodiments of the present disclosure provide a communication device. The communication device may include a transceiver module and a processing module. The transceiver module may include a transmitting module and/or a receiving module. The transmitting module is configured to implement a transmission function, and the receiving module is configured to implement a reception function. The transceiver module may implement the transmission function and/or the reception function.

The communication device may be a terminal device (such as the terminal device in the above method embodiments), a device in the terminal device, or a device that can be used in conjunction with the terminal device. Alternatively, the communication device may be a network device, a device in the network device, or a device that can be used in conjunction with the network device.

Embodiments of the present disclosure provide another communication device. The communication device may be a network device, or may be a terminal device (such as the terminal device in the above method embodiments), or may be a chip, a chip system, a processor or the like that supports the network device to implement the above method, or may be a chip, a chip system, a processor or the like that supports the terminal device to implement the above method. The device can be used to implement the method described in the above method embodiments. For details, reference may be made to the description in the above method embodiments.

The communication device may include one or more processors. The processor may be a general-purpose processor or a dedicated processor, or the like. For example, the processor may be a baseband processor or a central processing unit. The baseband processor can be used to process communication protocols and communication data. The central processor can be used to control the communication devices (such as network side devices, baseband chips, terminal devices, terminal device chips, DU or CU, or the like), execute computer programs, and process data for the computer programs.

In embodiments of the present disclosure, the communication device may further include one or more memories, on which a computer program may be stored. The processor executes the computer program, so that the communication device performs the method described in the above method embodiments. In embodiments of the present disclosure, the memory may also store data. The communication device and the memory can be provided separately or integrated together.

In embodiments of the present disclosure, the communication device may further include a transceiver and an antenna. The transceiver may be referred to as a transceiver unit, a transceiver, a transceiver circuit, or the like, and is used to implement transceiver functions. The transceiver may include a receiver and a transmitter. The receiver may be referred to as a receiver or a receiving circuit, or the like, and is used to implement the receiving function; and the transmitter may be referred to as a transmitter, a transmitting circuit, or the like, and is used to implement the transmitting function.

In embodiments of the present disclosure, the communication device may further include one or more interface circuits. The interface circuit is used to receive code instructions and transmit the code instructions to the processor. The processor executes the code instructions to cause the communication device to perform the method described in the above method embodiments.

The communication device is a terminal device (such as the terminal device in the foregoing method embodiments), and the processor is configured to execute the method shown in any one of FIGS. 1-5.

The communication device is a network device, and the transceiver is configured to execute the method shown in any one of FIGS. 6-10.

In an implementation of the present disclosure, the processor may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The above-mentioned transceiver circuit, interface or interface circuit can be used for reading and writing codes/data, or the above-mentioned transceiver circuit, interface or interface circuit can be used for signal transmission or transfer.

In an implementation of the present disclosure, the processor may be stored with a computer program, and the computer program is executed by the processor, causing the communication device to perform the method described in the above method embodiments. The computer program may be solidified in the processor, in which case the processor may be implemented by hardware.

In an implementation of the present disclosure, the communication device may include a circuit, and the circuit may implement the functions of sending or receiving or communicating in the foregoing method embodiments. The processors and transceivers described in the present disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication device described in the above embodiments may be the signal receiving end or the signal sending end (e.g., the signal sending end in the above method embodiments), but the scope of the communication device described in the present disclosure is not limited thereto, and the structure of the communication device may not be limited. The communication device may be a stand-alone device or may be part of a larger device. For example, the communication device may be:
(1) a stand-alone integrated circuit IC, or chip, or chip system or subsystem;
(2) a set of one or more ICs. In embodiments of the present disclosure, the IC set may further include storage components for storing data and computer programs;
(3) an ASIC, such as a modem;
(4) a module that can be embedded in another device;
(5) a receiver, a signal sending end, an intelligent signal sending end, a cellular phone, a wireless device, a handheld device, a mobile unit, a vehicle-mounted device, a network device, a cloud device, an artificial intelligence device, and the like;
(6) others, etc.

In a case that the communication device may be a chip or a system on a chip, the chip includes a processor and an interface. The number of processors may be one or more, and the number of interfaces may be multiple.

In an embodiment of the present disclosure, the chip further includes a memory, and the memory is configured to store necessary computer programs and data.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure further provide a system for determining a sidelink duration. The system includes the communication device as the signal sending end (such as the first signal sending end in the above method embodiments) and the communication device as the network device in the above embodiments, or the system includes the communication device as the signal sending end (such as the first signal sending end in the above method embodiments) and the communication device as the network device in the above embodiments.

The present disclosure further provides a readable storage medium on which instructions are stored. When the instructions are executed by a computer, the functions of any of the above method embodiments are implemented.

The present disclosure further provides a computer program product, which, when been executed by a computer, implements the functions of any of the above method embodiments.

The present disclosure provides a method/apparatus/device for transmitting a signal, and a storage medium, so as to solve a problem of transmission discarding when a communication signal and a sensing signal overlap.

An aspect of embodiments of the present disclosure provides a method for transmitting a signal, applied to a signal sending end, and the method includes:
determining a first transmission resource for a first signal and a second transmission resource for a second signal;
determining whether the first signal is overlapped with the second signal based on the first transmission resource and the second transmission resource;
determining a priority order of the first signal and the second signal in a case where the first signal is overlapped with the second signal; and
sending the first signal and/or the second signal based on the priority order of the first signal and the second signal;
wherein the first signal is a signal for sensing, and the second signal is a signal for communication.

In an embodiment of the present disclosure, determining whether the first signal is overlapped with the second signal based on the first transmission resource and the second transmission resource includes:
when the first transmission resource is overlapped with the second transmission resource, determining that the first signal is overlapped with the second signal.

In an embodiment of the present disclosure, determining whether the first signal is overlapped with the second signal based on the first transmission resource and the second transmission resource includes:
determining whether a transmission resource with a later starting position among the first transmission resource and the second transmission resource is overlapped with an interval between the first transmission resource and the second transmission resource; and when the transmission resource with the later starting position is overlapped with the interval, determining that the first signal is overlapped with the second signal.

In an embodiment of the present disclosure, a method for determining the priority order of the first signal and the second signal includes at least one of:
determining priorities of the first signal and the second signal based on a configuration by a network device, and determining the priority order based on the priorities of the first signal and the second signal;
determining the priority order of the first signal and the second signal based on a protocol agreement; or
autonomously determining, by the signal sending end, the priority order of the first signal and the second signal.

In an embodiment of the present disclosure, determining the priorities of the first signal and the second signal based on the configuration by the network device includes:
determining the priorities of the first signal and the second signal based on a parameter and/or a Downlink Control Information (DCI) signaling configured by the network device; and
in a case where the priorities of the first signal and the second signal are not configured by the network device, determining the first signal and the second signal have the same priority.

In an embodiment of the present disclosure, autonomously determining, by the signal sending end, the priority order of the first signal and the second signal includes:
determining a transmission scenario corresponding to the signal sending end; and
determining the priority order of the first signal and the second signal based on the transmission scenario corresponding to the signal sending end.

In an embodiment of the present disclosure, a method for determining the transmission scenario corresponding to the signal sending end includes at least one of:
determining the transmission scenario corresponding to the signal sending end based on a protocol agreement; or
determining the transmission scenario corresponding to the signal sending end based on an indication by the network device.

In an embodiment of the present disclosure, determining the priority order of the first signal and the second signal based on the transmission scenario corresponding to the signal sending end includes:
making a priority of a signal, among the first signal and the second signal, whose purpose corresponds to a requirement of the transmission scenario be higher than a priority of a signal, among the first signal and the second signal, whose purpose does not correspond to the requirement of the transmission scenario.

In an embodiment of the present disclosure, sending the first signal and/or the second signal based on the priority order of the first signal and the second signal includes:
in a case where the first signal and the second signal have different priorities, sending the first signal and/or the second signal by performing a first sending operation;
the first sending operation includes any one of:
discarding, on an overlapping resource, transmission of a low-priority signal among the first signal and the second signal;
discarding the transmission of the low-priority signal among the first signal and the second signal;
prioritizing transmission of a high-priority signal among the first signal and the second signal, and when the transmission of the high-priority signal is completed, transmitting, in a delayed manner, the low-priority signal among the first signal and the second signal;
prioritizing the transmission of the high-priority signal among the first signal and the second signal, and when the transmission of the high-priority signal is completed, transmitting, in the delayed manner, the low-priority signal among the first signal and the second signal; wherein an interval between the high-priority signal that is transmitted preferentially and the low-priority signal that is transmitted delayedly is greater than a threshold value;
transmitting the first signal on a first part of the overlapping resource, and transmitting the second signal on a second part of the overlapping resource, wherein the first part of the overlapping resource is not overlapped with the second part of the overlapping resource; or
transmitting the first signal on the first part of the overlapping resource, and transmitting the second signal on the second part of the overlapping resource, wherein the first part of the overlapping resource is not overlapped with the second part of the overlapping resource, and an interval between the first part of the overlapping resource and the second part of the overlapping resource is greater than a threshold value.

In an embodiment of the present disclosure, sending the first signal and/or the second signal based on the priority order of the first signal and the second signal includes:
in a case where the first signal and the second signal have the same priority, sending the first signal and/or the second signal by performing a second sending operation;
the second sending operation includes any one of:
discarding, on an overlapping resource, transmission of a signal with a later starting position among the first signal and the second signal;
discarding the transmission of the signal with the later starting position among the first signal and the second signal;
prioritizing transmission of a signal with an earlier starting position among the first signal and the second signal, and when the transmission of the signal with the earlier starting position is completed, transmitting, in a delayed manner, the signal with the later starting position among the first signal and the second signal;
prioritizing the transmission of the signal with the earlier starting position among the first signal and the second signal, and when the transmission of the signal with the earlier starting position is completed, transmitting, in the delayed manner, the signal with the later starting position among the first signal and the second signal, wherein an interval between the signal with the earlier starting position that is transmitted preferentially and the signal with the later starting position that is transmitted in the delayed manner is greater than a threshold value;
transmitting the first signal on a first part of the overlapping resource, and transmitting the second signal on a second part of the overlapping resource, wherein the first part of the overlapping resource is not overlapped with the second part of the overlapping resource;
transmitting the first signal on the first part of the overlapping resource, and transmitting the second signal on the second part of the overlapping resource, wherein the first part of the overlapping resource is not overlapped with the second part of the overlapping resource, and an interval between the first part of the overlapping resource and the second part of the overlapping resource is greater than a threshold value; or
transmitting the first signal or the second signal by default based on a protocol specification.

Another aspect of embodiments of the present disclosure provides a method for transmitting a signal, applied to a signal receiving end, and the method includes:
determining a first transmission resource for a first signal and a second transmission resource for a second signal;
determining whether the first signal is overlapped with the second signal based on the first transmission resource and the second transmission resource;
determining a priority order of the first signal and the second signal in a case where the first signal is overlapped with the second signal; and
receiving the first signal and/or the second signal based on the priority order of the first signal and the second signal;
wherein the first signal is a signal for sensing, and the second signal is a signal for communication.

In an embodiment of the present disclosure, determining whether the first signal is overlapped with the second signal based on the first transmission resource and the second transmission resource includes:
when the first transmission resource is overlapped with the second transmission resource, determining that the first signal is overlapped with the second signal.

In an embodiment of the present disclosure, determining whether the first signal is overlapped with the second signal based on the first transmission resource and the second transmission resource includes:
determining whether a transmission resource with a later starting position among the first transmission resource and the second transmission resource is overlapped with an interval between the first transmission resource and the second transmission resource; and
when the transmission resource with the later starting position is overlapped with the interval, determining that the first signal is overlapped with the second signal.

In an embodiment of the present disclosure, a method for determining the priority order of the first signal and the second signal includes at least one of:
determining priorities of the first signal and the second signal based on a configuration by a network device, and determining the priority order based on the priorities of the first signal and the second signal;
determining the priority order of the first signal and the second signal based on a protocol agreement; or
autonomously determining, by the signal receiving end, the priority order of the first signal and the second signal.

In an embodiment of the present disclosure, determining the priorities of the first signal and the second signal based on the configuration by the network device includes:
determining the priorities of the first signal and the second signal based on a parameter and/or a Downlink Control Information (DCI) signaling configured by the network device; and
in a case where the priorities of the first signal and the second signal are not configured by the network device, determining the first signal and the second signal have the same priority.

In an embodiment of the present disclosure, autonomously determining, by the signal receiving end, the priority order of the first signal and the second signal includes:
determining a transmission scenario corresponding to the signal receiving end; and
determining the priority order of the first signal and the second signal based on the transmission scenario corresponding to the signal receiving end.

In an embodiment of the present disclosure, a method for determining the transmission scenario corresponding to the signal receiving end includes at least one of:

determining the transmission scenario corresponding to the signal receiving end based on a protocol agreement; or
determining the transmission scenario corresponding to the signal receiving end based on an indication by the network device.

In an embodiment of the present disclosure, determining the priority order of the first signal and the second signal based on the transmission scenario corresponding to the signal sending end includes:
making a priority of a signal, among the first signal and the second signal, whose purpose corresponds to a requirement of the transmission scenario be higher than a priority of a signal, among the first signal and the second signal, whose purpose does not correspond to the requirement of the transmission scenario.

In an embodiment of the present disclosure, receiving the first signal and/or the second signal based on the priority order of the first signal and the second signal includes:
receiving the first signal and/or the second signal by performing a first receiving operation;
the first receiving operation includes any one of:
discarding, on an overlapping resource, reception of a low-priority signal among the first signal and the second signal;
discarding the reception of the low-priority signal among the first signal and the second signal;
prioritizing reception of a high-priority signal among the first signal and the second signal, and when the reception of the high-priority signal is completed, receiving, in a delayed manner, the low-priority signal among the first signal and the second signal;
prioritizing the reception of the high-priority signal among the first signal and the second signal, and when the reception of the high-priority signal is completed, receiving, in the delayed manner, the low-priority signal among the first signal and the second signal; wherein an interval between the high-priority signal that is received preferentially and the low-priority signal that is received in the delayed manner is greater than a threshold value;
receiving the first signal on a first part of the overlapping resource, and receiving the second signal on a second part of the overlapping resource, wherein the first part of the overlapping resource is not overlapped with the second part of the overlapping resource; or
receiving the first signal on a first part of the overlapping resource, and receiving the second signal on a second part of the overlapping resource, wherein the first part of the overlapping resource is not overlapped with the second part of the overlapping resource, and an interval between the first part of the overlapping resource and the second part of the overlapping resource is greater than a threshold value.

In an embodiment of the present disclosure, receiving the first signal and/or the second signal based on the priority order of the first signal and the second signal includes:
receiving the first signal and/or the second signal by performing a second receiving operation;
the second receiving operation includes any one of:
discarding, on an overlapping resource, reception of a signal with a later starting position among the first signal and the second signal;
discarding the reception of the signal with the later starting position among the first signal and the second signal;
prioritizing reception of a signal with an earlier starting position among the first signal and the second signal, and when the reception of the signal with the earlier starting position is completed, receiving, in a delayed manner, the signal with the later starting position among the first signal and the second signal;
prioritizing the reception of the signal with the earlier starting position among the first signal and the second signal, and when the reception of the signal with the earlier starting position is completed, receiving, in the delayed manner, the signal with the later starting position among the first signal and the second signal, wherein an interval between the signal with the earlier starting position that is received preferentially and the signal with the later starting position that is received in the delayed manner is greater than a threshold value;
receiving the first signal on a first part of the overlapping resource, and receiving the second signal on a second part of the overlapping resource, wherein the first part of the overlapping resource is not overlapped with the second part of the overlapping resource;
receiving the first signal on a first part of the overlapping resource, and receiving the second signal on a second part of the overlapping resource, wherein the first part of the overlapping resource is not overlapped with the second part of the overlapping resource, and an interval between the first part of the overlapping resource and the second part of the overlapping resource is greater than a threshold value; or
receiving the first signal or the second signal by default based on a protocol specification.

Yet another aspect of embodiments of the present disclosure provides an apparatus for transmitting a signal, including:
a first determination module, configured to determine a first transmission resource for a first signal and a second transmission resource for a second signal;
a second determination module, configured to determine whether the first signal is overlapped with the second signal based on the first transmission resource and the second transmission resource;
a third determination module, configured to determine a priority order of the first signal and the second signal in a case where the first signal is overlapped with the second signal; and
a sending module, configured to send the first signal and/or the second signal based on the priority order of the first signal and the second signal;
wherein the first signal is a signal for sensing, and the second signal is a signal for communication.

Still another aspect of embodiments of the present disclosure provides an apparatus for transmitting a signal, including:
a first determination module, configured to determine a first transmission resource for a first signal and a second transmission resource for a second signal;
a second determination module, configured to determine whether the first signal is overlapped with the second signal based on the first transmission resource and the second transmission resource;
a third determination module, configured to determine a priority order of the first signal and the second signal in a case where the first signal is overlapped with the second signal; and
a receiving module, configured to receive the first signal and/or the second signal based on the priority order of the first signal and the second signal;
wherein the first signal is a signal for sensing, and the second signal is a signal for communication.

Still another aspect of embodiments of the present disclosure provides a communication device, including a processor and a memory, wherein a computer program is stored in the memory, and the processor executes the computer program stored in the memory to cause the communication device to execute the method provided in the aspect of the above embodiments.

Still another aspect of embodiments of the present disclosure provides a communication device, including a processor and a memory, wherein a computer program is stored in the memory, and the processor executes the computer program stored in the memory to cause the communication device to execute the method provided in the other aspect of the above embodiments.

Still another aspect of embodiments of the present disclosure provides a communication device, including a processor and an interface circuit; and
wherein the interface circuit is configured to receive code instructions and transmit the code instructions to the processor; and
the processor is configured to run the code instructions to execute the method provided in the aspect of the above embodiments.

Still another aspect of embodiments of the present disclosure provides a communication device, including a processor and an interface circuit; and
wherein interface circuit is configured to receive code instructions and transmit the code instructions to the processor; and
the processor is configured to run the code instructions to execute the method provided in the other aspect of the above embodiments.

Still another aspect of embodiments of the present disclosure provides a computer-readable storage medium, configured to store instructions, wherein the instructions, when executed, cause the method provided in the aspect of the above embodiments.

Still another aspect of embodiments of the present disclosure provides a computer-readable storage medium, configured to store instructions, wherein the instructions, when executed, cause the method provided in the other aspect of the above embodiments.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in the present disclosure are only distinctions made for convenience of description and are not used to limit the scope of the embodiments of the disclosure, nor to indicate the order.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for transmitting a signal, performed by a signal sending end, and comprising:
determining a first transmission resource for a first signal and a second transmission resource for a second signal;
determining whether the first signal is overlapped with the second signal based on the first transmission resource and the second transmission resource;
determining a priority order of the first signal and the second signal in a case where the first signal is overlapped with the second signal; and
sending at least one of the first signal and/or or the second signal based on the priority order of the first signal and the second signal;
wherein the first signal is a signal for sensing, and the second signal is a signal for communication.

2. The method according to claim 1, wherein determining whether the first signal is overlapped with the second signal based on the first transmission resource and the second transmission resource comprises:
in a case where the first transmission resource is overlapped with the second transmission resource, determining that the first signal is overlapped with the second signal; or
determining whether a transmission resource with a later starting position among the first transmission resource and the second transmission resource is overlapped with an interval between the first transmission resource and the second transmission resource; and in a case where the transmission resource with the later starting position is overlapped with the interval, determining that the first signal is overlapped with the second signal.

3. (canceled)

4. The method according to claim 1, wherein determining the priority order of the first signal and the second signal comprises at least one of:
determining priorities of the first signal and the second signal based on a configuration by a network device, and determining the priority order based on the priorities of the first signal and the second signal;
determining the priority order of the first signal and the second signal based on a protocol agreement; or
autonomously determining, by the signal sending end, the priority order of the first signal and the second signal.

5. The method according to claim 4, wherein determining the priorities of the first signal and the second signal based on the configuration by the network device comprises:
determining the priorities of the first signal and the second signal based on at least one of a parameter or a Downlink Control Information (DCI) signaling configured by the network device; and
in a case where the priorities of the first signal and the second signal are not configured by the network device, determining the first signal and the second signal have the same priority.

6. The method according to claim 4, wherein autonomously determining, by the signal sending end, the priority order of the first signal and the second signal comprises:
determining a transmission scenario corresponding to the signal sending end; and
determining the priority order of the first signal and the second signal based on the transmission scenario corresponding to the signal sending end.

7. The method according to claim 6, wherein determining the transmission scenario corresponding to the signal sending end comprises at least one of:
determining the transmission scenario corresponding to the signal sending end based on a protocol agreement; or
determining the transmission scenario corresponding to the signal sending end based on an indication by the network device.

8. The method according to claim 6, wherein determining the priority order of the first signal and the second signal based on the transmission scenario corresponding to the signal sending end comprises:
making a priority of a signal, among the first signal and the second signal, whose purpose corresponds to a requirement of the transmission scenario be higher than a priority of a signal, among the first signal and the second signal, whose purpose does not correspond to the requirement of the transmission scenario.

9. The method according to claim 2, wherein sending the at least one of the first signal or the second signal based on the priority order of the first signal and the second signal comprises:
in a case where the first signal and the second signal have different priorities, sending the at least one of the first signal or the second signal by performing a first sending operation;
the first sending operation comprises any one of:
discarding, on an overlapping resource, transmission of a low-priority signal among the first signal and the second signal;
discarding the transmission of the low-priority signal among the first signal and the second signal;
prioritizing transmission of a high-priority signal among the first signal and the second signal, and when the transmission of the high-priority signal is completed, transmitting, in a delayed manner, the low-priority signal among the first signal and the second signal;
prioritizing the transmission of the high-priority signal among the first signal and the second signal, and when the transmission of the high-priority signal is completed, transmitting, in the delayed manner, the low-priority signal among the first signal and the second signal, wherein an interval between the high-priority signal that is transmitted preferentially and the low-priority signal that is transmitted in the delayed manner is greater than a threshold value;
transmitting the first signal on a first part of the overlapping resource, and transmitting the second signal on a second part of the overlapping resource, wherein the first part of the overlapping resource is not overlapped with the second part of the overlapping resource; or
transmitting the first signal on the first part of the overlapping resource, and transmitting the second signal on the second part of the overlapping resource, wherein the first part of the overlapping resource is not overlapped with the second part of the overlapping resource, and an interval between the first part of the overlapping resource and the second part of the overlapping resource is greater than a threshold value.

10. The method according to claim 2, wherein sending the at least one of the first signal or the second signal based on the priority order of the first signal and the second signal comprises:
in a case where the first signal and the second signal have the same priority, sending the at least one of the first signal or the second signal by performing a second sending operation;
the second sending operation comprises any one of:
discarding, on an overlapping resource, transmission of a signal with a later starting position among the first signal and the second signal;
discarding the transmission of the signal with the later starting position among the first signal and the second signal;
prioritizing transmission of a signal with an earlier starting position among the first signal and the second signal, and when the transmission of the signal with the earlier starting position is completed, transmitting, in a delayed manner, the signal with the later starting position among the first signal and the second signal;
prioritizing the transmission of the signal with the earlier starting position among the first signal and the second signal, and when the transmission of the signal with the earlier starting position is completed, transmitting, in the delayed manner, the signal with the later starting position among the first signal and the second signal, wherein an interval between the signal with the earlier starting position that is transmitted preferentially and the signal with the later starting position that is transmitted in the delayed manner is greater than a threshold value;
transmitting the first signal on a first part of the overlapping resource, and transmitting the second signal on a second part of the overlapping resource, wherein the first part of the overlapping resource is not overlapped with the second part of the overlapping resource;
transmitting the first signal on the first part of the overlapping resource, and transmitting the second signal on the second part of the overlapping resource, wherein the first part of the overlapping resource is not overlapped with the second part of the overlapping resource, and an interval between the first part of the overlapping resource and the second part of the overlapping resource is greater than a threshold value; or
transmitting the first signal or the second signal by default based on a protocol specification.

11. A method for transmitting a signal, performed by a signal receiving end, and comprising:
determining a first transmission resource for a first signal and a second transmission resource for a second signal;
determining whether the first signal is overlapped with the second signal based on the first transmission resource and the second transmission resource;
determining a priority order of the first signal and the second signal in a case where the first signal is overlapped with the second signal; and
receiving at least one of the first signal or the second signal based on the priority order of the first signal and the second signal;
wherein the first signal is a signal for sensing, and the second signal is a signal for communication.

12. The method according to claim 11, wherein determining whether the first signal is overlapped with the second signal based on the first transmission resource and the second transmission resource comprises:
in a case where the first transmission resource is overlapped with the second transmission resource, determining that the first signal is overlapped with the second signal; or
determining whether a transmission resource with a later starting position among the first transmission resource and the second transmission resource is overlapped with an interval between the first transmission resource and the second transmission resource; and in a case where the transmission resource with the later starting position is overlapped with the interval, determining that the first signal is overlapped with the second signal.

13. (canceled)

14. The method according to claim 11, wherein determining the priority order of the first signal and the second signal comprises at least one of:
determining priorities of the first signal and the second signal based on a configuration by a network device, and determining the priority order based on the priorities of the first signal and the second signal;
determining the priority order of the first signal and the second signal based on a protocol agreement; or
autonomously determining, by the signal receiving end, the priority order of the first signal and the second signal.

15. The method according to claim 14, wherein determining the priorities of the first signal and the second signal based on the configuration by the network device comprises:
determining the priorities of the first signal and the second signal based on at least one of a parameter or a DCI signaling configured by the network device; and
in a case where the priorities of the first signal and the second signal are not configured by the network device, determining the first signal and the second signal have the same priority.

16. The method according to claim 14, wherein autonomously determining, by the signal receiving end, the priority order of the first signal and the second signal comprises:
determining a transmission scenario corresponding to the signal receiving end; and
determining the priority order of the first signal and the second signal based on the transmission scenario corresponding to the signal receiving end.

17. The method according to claim 16, wherein determining the transmission scenario corresponding to the signal receiving end comprises at least one of:
determining the transmission scenario corresponding to the signal receiving end based on a protocol agreement; or
determining the transmission scenario corresponding to the signal receiving end based on an indication by the network device.

18. The method according to claim 16, wherein determining the priority order of the first signal and the second signal based on the transmission scenario corresponding to the signal receiving end comprises:
making a priority of a signal, among the first signal and the second signal, whose purpose corresponds to a requirement of the transmission scenario be higher than a priority of a signal, among the first signal and the second signal, whose purpose does not correspond to the requirement of the transmission scenario.

19. The method according to claim 12, wherein receiving the at least one of the first signal or the second signal based on the priority order of the first signal and the second signal comprises:
receiving the at least one of the first signal or the second signal by performing a first receiving operation;
the first receiving operation comprises any one of:
discarding, on an overlapping resource, reception of a low-priority signal among the first signal and the second signal;
discarding the reception of the low-priority signal among the first signal and the second signal;
prioritizing reception of a high-priority signal among the first signal and the second signal, and when the reception of the high-priority signal is completed, receiving, in a delayed manner, the low-priority signal among the first signal and the second signal;
prioritizing the reception of the high-priority signal among the first signal and the second signal, and when the reception of the high-priority signal is completed, receiving, in the delayed manner, the low-priority signal among the first signal and the second signal, wherein an interval between the high-priority signal that is received preferentially and the low-priority signal that is received in the delayed manner is greater than a threshold value;
receiving the first signal on a first part of the overlapping resource, and receiving the second signal on a second part of the overlapping resource, wherein the first part of the overlapping resource is not overlapped with the second part of the overlapping resource; or
receiving the first signal on the first part of the overlapping resource, and receiving the second signal on the second part of the overlapping resource, wherein the first part of the overlapping resource is not overlapped with the second part of the overlapping resource, and an interval between the first part of the overlapping resource and the second part of the overlapping resource is greater than a threshold value.

20. The method according to claim 12, wherein receiving the at least one of the first signal or the second signal based on the priority order of the first signal and the second signal comprises:
receiving the at least one of the first signal or the second signal by performing a second receiving operation;
the second receiving operation comprises any one of:
discarding, on an overlapping resource, reception of a signal with a later starting position among the first signal and the second signal;
discarding the reception of the signal with the later starting position among the first signal and the second signal;
prioritizing reception of a signal with an earlier starting position among the first signal and the second signal, and when the reception of the signal with the earlier starting position is completed, receiving, in a delayed manner, the signal with the later starting position among the first signal and the second signal;
prioritizing the reception of the signal with the earlier starting position among the first signal and the second signal, and when the reception of the signal with the earlier starting position is completed, receiving, in the delayed manner, the signal with the later starting position among the first signal and the second signal, wherein an interval between the signal with the earlier starting position that is received preferentially and the signal with the later starting position that is received in the delayed manner is greater than a threshold value;
receiving the first signal on a first part of the overlapping resource, and receiving the second signal on a second part of the overlapping resource, wherein the first part of the overlapping resource is not overlapped with the second part of the overlapping resource;
receiving the first signal on a first part of the overlapping resource, and receiving the second signal on a second part of the overlapping resource, wherein the first part of the overlapping resource is not overlapped with the second part of the overlapping resource, and an interval between the first part of the overlapping resource and the second part of the overlapping resource is greater than a threshold value; or receiving the first signal or the second signal by default based on a protocol specification.

21. (canceled)

22. (canceled)

23. A communication device, comprising:
a processor; and
a memory, storing a computer program executable by the processor;
wherein the processor is configured to:
determine a first transmission resource for a first signal and a second transmission resource for a second signal;
determine whether the first signal is overlapped with the second signal based on the first transmission resource and the second transmission resource;
determine a priority order of the first signal and the second signal in a case where the first signal is overlapped with the second signal; and
send at least one of the first signal or the second signal based on the priority order of the first signal and the second signal;
wherein the first signal is a signal for sensing, and the second signal is a signal for communication.

24. A communication device, comprising:
a processor; and
a memory, storing a computer program executable by the processor;
wherein the processor is configured to perform the method according to claim 11.

25.-28. (canceled)
